(19) United States
(12) Patent Application Publication
(10) Pub. No.: US 2025/0285595 A1
(43) Pub. Date: Sep. 11, 2025

(54) DISPLAY DEVICE

(71) Applicant: Samsung Display Co., LTD., Yongin-si (KR)

(72) Inventor: Su Min YANG, Yongin-si (KR)

(21) Appl. No.: 18/952,737

(22) Filed: Nov. 19, 2024

(30) Foreign Application Priority Data
Mar. 8, 2024 (KR) 10-2024-0032965

(51) Int. Cl. G09G 3/3258; G09G 3/3291

(52) U.S. Cl. CPC G09G 3/3258; G09G 3/3291; G09G 2310/027; G09G 2310/08; G09G 2320/045

(57) ABSTRACT

A display device includes: a display panel in which a plurality of pixels are arranged in a display area to display an image; a scan driving circuit configured to supply compensation gate scan signals to the pixels on a horizontal line-by-horizontal line basis through compensation gate lines of the display area; a data driving circuit unit configured to: detect pixel driving voltages output from the pixels by the compensation gate scan signals; compensate and modulate data voltages using compensation data set by the pixel driving voltages; and supply the data voltages to data lines of the display area; and a display driving circuit configured to control a pixel driving voltage detection direction and order of the data driving circuit unit by supplying a direction switching signal to the data driving circuit unit.

### CROSS-REFERENCE TO RELATED APPLICATION

The present application claims priority to and the benefit of Korean Patent

Application No. 10-2024-0032965, filed on Mar. 8, 2024, in the Korean Intellectual Property Office the entire disclosure of which is incorporated herein by reference.

### BACKGROUND

### 1. Field

Aspects of some embodiments of the present disclosure relate to a display device.

### 2. Description of the Related Art

As the information society develops, consumer demand for display devices for displaying images is increasing in various forms. For example, display devices may be applied to various electronic devices such as smartphones, digital cameras, notebook computers, navigation devices, and smart televisions.

The display devices may be flat panel display devices such as liquid crystal display devices, field emission display devices, and organic light emitting display devices. Among these flat panel display devices, a light emitting display device includes a light emitting element that enables each pixel of a display panel to emit light by itself. Thus, the light emitting display device may be capable of displaying images without a backlight unit that provides light to the display panel.

A display device includes a display panel including data lines, scan signal lines and a plurality of pixels connected to the data lines and the scan signal lines, a scan driver supplying scan signals to the scan signal lines, and a data driver supplying data voltages to the data lines.

The scan driver may sequentially supply scan signals to the scan signal lines, and the data driver supplies data voltages to the data lines in units of at least one horizontal line. The data driver may detect driving voltages and currents of light emitting elements from a plurality of pixels, compensate the data voltages according to the detection result, and supply the data voltages to the data lines.

The above information disclosed in this Background section is only for enhancement of understanding of the background and therefore the information discussed in this Background section does not necessarily constitute prior art.

### SUMMARY

Aspects of some embodiments of the present disclosure include a display device which can control integrated circuits located adjacent to each other among integrated circuits of a data driver to detect driving voltages of pixels (e.g., driving voltages of light emitting elements) in orders of different directions.

Aspects of some embodiments of the present disclosure also provide a display device which can change pixel driving voltage detection directions and orders of integrated circuits adjacent to each other to different directions and orders in units of at least one frame period and compensate data voltages according to the result of pixel driving voltage detection.

However, aspects of some embodiments of the present disclosure are not restricted to those specifically set forth herein. The above and other aspects of embodiments according to the present disclosure will become more apparent to one of ordinary skill in the art to which the present disclosure pertains by referencing the detailed description of the present disclosure given below.

According to some embodiments of the present disclosure, a display device includes: a display panel in which a plurality of pixels are arranged in a display area to display an image, a scan driving circuit supplying compensation gate scan signals to the pixels on a horizontal line-by-horizontal line basis through compensation gate lines of the display area, a data driving circuit unit detecting pixel driving voltages output from the pixels by the compensation gate scan signals, compensating and modulating data voltages using compensation data set by the pixel driving voltages, and supplying the data voltages to data lines of the display area, and a display driving circuit controlling a pixel driving voltage detection direction and order of the data driving circuit unit by supplying a direction switching signal to the data driving circuit unit.

According to some embodiments of the present disclosure, a display device comprising a display panel in which a plurality of pixels are arranged in a display area to display an image, a scan driving circuit supplying compensation gate scan signals to the pixels on a horizontal line-by-horizontal line basis through compensation gate lines of the display area, a plurality of data driving integrated circuits detecting pixel driving voltages output from the pixels by the compensation gate scan signals, compensating and modulating data voltages using compensation data set by the pixel driving voltages, and supplying the data voltages to data lines of the display area, and a display driving circuit supplying first and second direction switching signals different from each other to data driving integrated circuits adjacent to each other among the data driving integrated circuits so that the data driving integrated circuits adjacent to each other can detect the pixel driving voltages, which are received from the pixels, in orders of first and second horizontal directions different from each other.

In a display device according to some embodiments of the present disclosure, integrated circuits adjacent to each other may be driven by changing their pixel driving voltage detection directions and orders to different directions and orders. Therefore, it may be possible to reduce a difference between the amounts of distortion of pixel driving voltages, for example, a difference between the amounts of drop of pixel driving voltages detected by each integrated circuit.

In addition, in a display device according to some embodiments, pixel driving voltages are detected by minimizing a difference between the amounts of distortion of pixel driving voltages of pixels at a boundary of a pixel driving area for each integrated circuit, and data voltages are compensated according to the result of pixel driving voltage detection. Therefore, image display defects can be prevented or reduced.

However, the characteristics of embodiments according to the present disclosure are not restricted to those set forth herein. The above and other characteristics of embodiments according to the present disclosure will become more apparent to one of daily skill in the art to which the present disclosure pertains by referencing the claims.

### BRIEF DESCRIPTION OF THE DRAWINGS

These and/or other aspects will become apparent and more readily appreciated from the following description of the embodiments, taken in conjunction with the accompanying drawings in which:

FIG. 1 is a plan view of a display device according to some embodiments of the present disclosure;

FIG. 2 is a detailed lateral cross-sectional view of the display device of FIG. 1;

FIG. 3 is a block diagram illustrating an electrical connection relationship between a display panel and drivers illustrated in FIGS. 1 and 2;

FIG. 4 is an equivalent circuit diagram illustrating aspects of a pixel of the display panel illustrated in FIG. 3 according to some embodiments;

FIG. 5 is a block diagram illustrating a connection structure between a

display driver, a plurality of data driving integrated circuits, and a pixel driving area for each integrated circuit according to some embodiments;

FIG. 6 is a detailed block diagram of any one data driving integrated circuit illustrated in FIG. 5;

FIG. 7 is a block diagram illustrating pixel driving voltage detection directions of data driving integrated circuits according to some embodiments of the present disclosure;

FIG. 8 is a block diagram illustrating pixel driving voltage detection directions of data driving integrated circuits according to some embodiments of the present disclosure;

FIG. 9 is a perspective view illustrating an application example of a display device according to some embodiments of the present disclosure;

FIG. 10 is a perspective view illustrating an application example of a display device according to some embodiments of the present disclosure;

FIG. 11 is a perspective view illustrating an application example of a display device according to some embodiments of the present disclosure; and

FIG. 12 is a perspective view illustrating an application example of a display device according to some embodiments of the present disclosure.

### DETAILED DESCRIPTION

Aspects of some embodiments of the present disclosure will now be described more fully hereinafter with reference to the accompanying drawings, in which aspects of some embodiments according to the present disclosure are shown. This disclosure may, however, be embodied in different forms and should not be construed as limited to the embodiments set forth herein. Rather, these embodiments are provided so that this disclosure will be more thorough and more complete, and will more fully convey the scope of embodiments according to the present disclosure to those skilled in the art.

It will also be understood that when a layer is referred to as being “on” another layer or substrate, it can be directly on the other layer or substrate, or intervening layers may also be present. The same reference numbers indicate the same components throughout the specification.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element.

Each of the features of the various embodiments of the present disclosure may be combined or combined with each other, in part or in whole, and technically various interlocking and driving are possible. Each embodiment may be implemented independently of each other or may be implemented together in an association.

Hereinafter, aspects of some embodiments will be described in more detail with reference to the accompanying drawings.

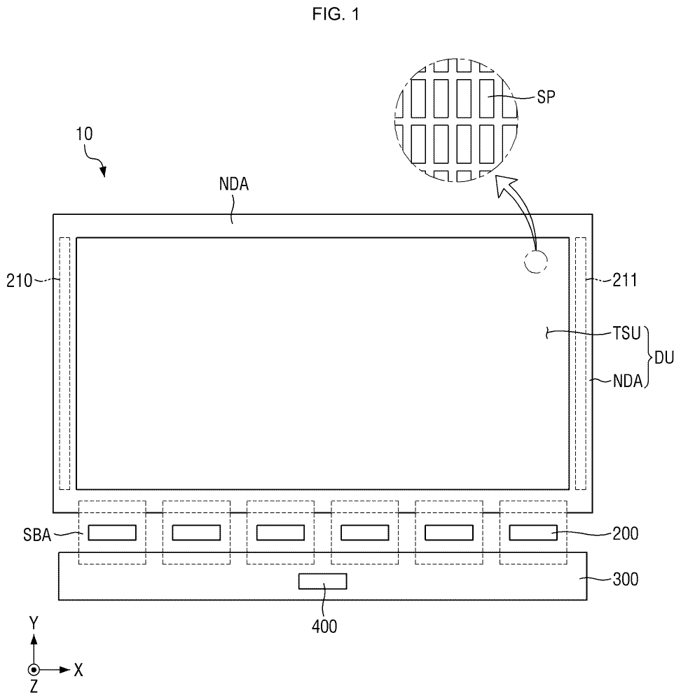

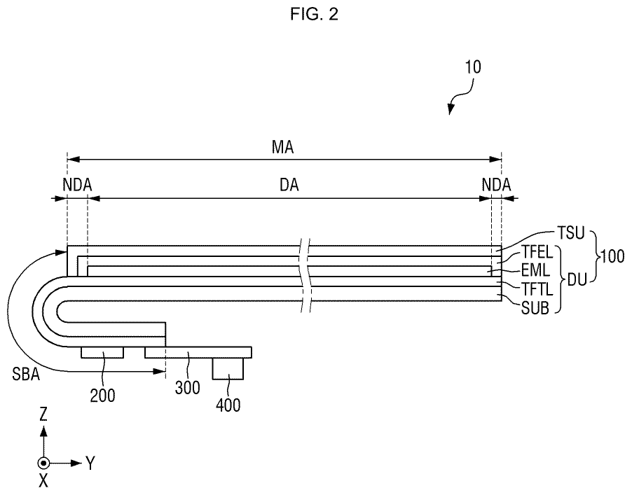

FIG. 1 is a plan view of a display device 10 according to some embodiments of the present disclosure. FIG. 2 is a detailed lateral cross-sectional view of the display device 10 of FIG. 1.

Referring to FIGS. 1 and 2, the display device 10 according to some embodiments may be applied to portable electronic devices such as tablet personal computers (PCs), portable multimedia players (PMPs), navigation devices, ultra-mobile PCs (UMPCs), electronic books, electronic notebooks, mobile phones, smartphones, and mobile communication terminals. For example, the display device 10 may be applied as a display unit of a television, a notebook computer, a monitor, a billboard, or an Internet of things (IoT) device.

The display device 10 according to some embodiments may be variously classified according to a display method. For example, the display device 10 may be classified and configured as an organic light emitting diode display device, an inorganic electroluminescent (EL) display device, a quantum dot light emitting display device (QED), a micro-light emitting diode display device, a nano-light emitting diode display device, a plasma display panel (PDP), a field emission display (FED) device, a liquid crystal display (LCD) device, or an electrophoretic display (EPD) device. An organic light emitting diode display device will be described below as an example of the display device 10 according to some embodiments. Unless a special distinction is required, the organic light emitting diode display device applied to embodiments will be shortened to the display device 10. However, the display device 10 according to some embodiments is not limited to the organic light emitting diode display device, and other display devices listed above or known in the art can also be applied within the spirit and scope of embodiments according to the present disclosure.

The display device 10 according to some embodiments may have a rectangular shape, a square shape, a circular shape, an oval shape, or a quadrate shape in a plan view. In addition, when the display device 10 is a mobile device such as a tablet PC, it may have a rectangular shape with its long sides located in a horizontal direction. However, embodiments according to the present disclosure are not limited thereto, and the long sides may also be located in a vertical direction, or the display device 10 may be rotatably installed so that the long sides can be variably located in the horizontal or vertical direction.

The display device 10 includes a display panel 100, a touch sensing unit TSU, first and second scan driving circuits 210 and 211, a data driving circuit unit 200, and a display driving circuit 400.

The display panel 100 of the display device 10 includes a display unit DU which displays an image, and the touch sensing unit TSU which detects a touch of a human body part such as a finger or an electronic pen is located on the display panel 100. The display unit DU of the display panel 100 may include a plurality of subpixels SP and display an image through the subpixels SP. In addition, the touch sensing unit TSU of the display panel 100 may be mounted on the front of the display panel 100 or may be formed integrally with the display panel 100. The touch sensing unit TSU may include a plurality of touch electrodes and may detect a user's touch in a capacitive manner using the touch electrodes.

The first scan driving circuit 210 supplies a gate scan signal to the pixels SP for each horizontal line through a gate line for each horizontal line of the display unit DU based on a gate control signal from the display driving circuit 400. The first scan driving circuit 210 sequentially drives the pixels SP on a horizontal line-by-horizontal line basis by sequentially supplying gate scan signals to the gate lines for the horizontal lines. In addition, the second scan driving circuit 211 supplies compensation gate scan signals to compensation gate lines for the horizontal lines of the display unit DU based on a gate control signal. The second scan driving circuit 211 controls pixel driving voltages of the pixels SP to be output on a horizontal line-by-horizontal line basis by sequentially supplying the compensation gate scan signals to the compensation gate lines for the horizontal lines.

The data driving circuit unit 200 may include a plurality of data driving integrated circuits. The data driving circuit unit 200 outputs data voltages according to image data to the pixels SP of the display unit DU based on a data driving control signal from the display driving circuit 400. The data driving integrated circuits may supply the data voltages to data lines, to which the pixels SP are connected, on a horizontal line-by-horizontal line basis every horizontal period.

The data driving circuit unit 200 receives and detects pixel driving voltages of the pixels SP on a horizontal line-by-horizontal line basis every horizontal period. For example, the data driving integrated circuits of the data driving circuit unit 200 may sequentially detect pixel driving voltages received from the pixels SP for each horizontal line in each horizontal period by switching the pixel driving voltages to an X-axis direction which is a first horizontal direction. Conversely, the data driving integrated circuits of the data driving circuit unit 200 may sequentially detect pixel driving voltages received from the pixels SP for each horizontal line in each horizontal period by switching the pixel driving voltages to a −X axis direction which is a second horizontal direction.

If all of the data driving integrated circuits detect pixel driving voltages in any one horizontal direction, a difference between the amounts of drop of the pixel driving voltages at each boundary of a pixel driving area for each data driving integrated circuit may increase. That is, because a boundary portion of each pixel driving area at a start time of pixel driving voltage detection is adjacent to a boundary portion of each pixel driving area at an end time of pixel driving voltage detection, a difference between the amounts of distortion of pixel driving voltages detected in the boundary portion of each pixel driving area increases. In this case, a difference in compensation size between the boundary portions also increases, causing defects such as image distortion in the boundary portions.

The data driving integrated circuits may detect pixel driving voltages by changing their pixel driving voltage detection directions and orders to different directions and orders from each other in units of at least one frame period under the control of the display driving circuit 400. For example, data driving integrated circuits located adjacent to each other among the data driving integrated circuits may sequentially switch pixel driving voltages, which are received from the pixels SP for each horizontal line, to the X-axis direction which is the first horizontal direction and the −X-axis direction which the second horizontal direction and detect the pixel driving voltages in orders of the different directions. Then, the data driving integrated circuits may compare and analyze the pixel driving voltages of the pixels SP detected in the orders of the different directions with a reference voltage for each image gray level, compensate data voltages with compensation data according to the analysis result, and supply the compensated data voltages to the data lines.

The display driving circuit 400 may operate as a main processor or may be formed integrally with the main processor. Accordingly, the display driving circuit 400 may control the overall function of the display device 10. For example, the display driving circuit 400 sorts image data from the outside and supplies the sorted image data to the data driving integrated circuits of the data driving circuit unit 200 and controls the driving timing of the data driving circuit unit 200. In addition, the display driving circuit 400 controls the gate scan signal output timings of the first and second scan driving circuits 210 and 211. The display driving circuit 400 generates data control signals to control the data voltage output timings of the data driving integrated circuits included in the data driving circuit unit 200. In addition, the display driving circuit 400 controls the pixel driving voltage detection directions and orders of the data driving integrated circuits.

The display driving circuit 400 may detect touch coordinate information included in touch data of the touch sensing unit TSU and then generate digital video data according to the touch coordinate information. In addition, the display driving circuit 400 may execute an application indicated by an icon displayed at a user's touch coordinates. For another example, the display driving circuit 400 may receive coordinate data from an electronic pen, determine touch coordinates of the electronic pen, and then generate digital video data according to the touch coordinates or execute an application indicated by an icon displayed at the touch coordinates of the electronic pen.

Referring to FIG. 2, the display panel 100 may be divided into a main area MA and a sub-area SBA. The main area MA may include a display area DA having the subpixels SP for displaying images and a non-display area NDA arranged around (e.g., in a periphery or outside a footprint of) the display area DA. In the display area DA, light may be emitted from an emission area or opening area of each subpixel SP to display an image. To this end, each subpixel SP of the display area DA may include a pixel circuit including switching elements, a pixel defining layer defining the emission area or the opening area, and a self-light emitting element.

The non-display area NDA may be any one peripheral area of the display area or an area outside the display area DA. The non-display area NDA may be defined as an edge area of the main area MA of the display panel 100. In the non-display area NDA, the first and second scan driving circuits 210 and 211, the data driving circuit unit 200, and fan-out lines connecting the display driving circuit 400 and the display area DA may be formed.

The sub-area SBA may extend from a side of the main area MA. The sub-area SBA may be made of a flexible film that can be bent, folded, rolled, etc. For example, when the sub-area SBA is bent, it may be overlapped by the main area MA in a thickness direction (Z-axis direction). The sub-area SBA may include the data driving circuit unit 200 and a pad unit connected to a circuit board 300. Optionally, the sub-area SBA may be omitted, and the data driving circuit unit 200 and the pad unit may be located in the non-display area NDA.

The data driving circuit unit 200 may be formed as a plurality of integrated circuits and mounted on the display panel 100 using a chip on glass (COG) method, a chip on plastic (COP) method, or an ultrasonic bonding method. For example, the data driving circuit unit 200 may be located in the sub-area SBA and may be overlapped by the main area MA in the thickness direction (Z-axis direction) by the bending of the sub-area SBA. For another example, the data driving circuit unit 200 may be mounted on the circuit board 300.

The circuit board 300 may be electrically connected to the pad unit of the display panel 100 by an anisotropic conductive film (ACF). To this end, lead lines of the circuit board 300 may be electrically connected to the pad unit of the display panel 100. The circuit board 300 may be a flexible printed circuit board, a printed circuit board, or a flexible film such as a chip on film.

The display driving circuit 400 may be mounted on the circuit board 300. The display driving circuit 400 may be formed as an integrated circuit.

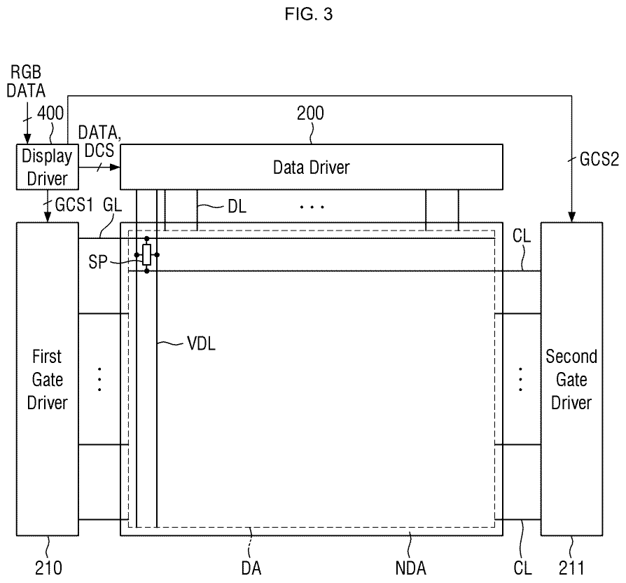

FIG. 3 is a block diagram illustrating an electrical connection relationship between the display panel 100 and drivers illustrated in FIGS. 1 and 2.

Referring to FIG. 3, a plurality of pixels SP are arranged in a matrix type in the display area DA. Although FIG. 3 illustrates a single pixel SP, as a person having ordinary skill in the art would appreciate, the display panel 100 may include any suitable number of pixels SP according to the design and size of the display panel 100. In addition, a plurality of gate lines GL, each connected to the pixels SP for a horizontal line, and a plurality of compensation gate lines CL, each connected to the pixels SP for a horizontal line, are arranged in the display area DA and the non-display area NDA.

The gate lines GL and the compensation gate lines CL may extend in the X-axis direction which is the first horizontal direction and may be spaced apart from each other in a first vertical direction intersecting the first horizontal direction. The gate lines GL and the compensation gate lines CL may be arranged at regular intervals along the first vertical direction.

The first scan driving circuit 210 supplies a gate scan signal to the pixels SP for each horizontal line through a gate line GL for each horizontal line based on a gate control signal GCS from the display driving circuit 400. The gate lines GL sequentially supply gate scan signals, which are sequentially generated in each horizontal period from the first scan driving circuit 210, to the pixels SP on a horizontal line-by-horizontal line basis.

The second scan driving circuit 211 controls pixel driving voltages of the pixels SP to be output on a horizontal line-by-horizontal line basis by sequentially supplying compensation gate scan signals to the compensation gate lines CL for the horizontal lines. The compensation gate lines CL sequentially supply the compensation gate scan signals, which are sequentially generated in each horizontal period from the second scan driving circuit 211, to the pixels SP on a horizontal line-by-horizontal line basis.

The gate scan signals of the first scan driving circuit 210 and the

compensation gate scan signals of the second scan driving circuit 211 may be generated alternately at different timings in different horizontal periods. For example, a gate scan signal may first be supplied to a gate line GL in each horizontal period, and a compensation gate scan signal may be supplied to a compensation gate line CL in each next horizontal period.

In addition, a plurality of data lines DL, each connected to the pixels SP for a vertical line, are arranged in the display area DA and the non-display area NDA. The data lines DL are electrically connected to the data driving circuit unit 200. A data voltage may determine an emission luminance of each of the pixels SP. In addition, a plurality of voltage detection lines VDL, each connected to the pixels SP for a vertical line, are arranged in the display area DA and the non-display area NDA. The voltage detection lines VDL are electrically connected to the data driving circuit unit 200. The pixels SP for a horizontal line share pixel driving voltages with the voltage detection lines VDL, respectively, in response to a compensation gate scan signal input in each horizontal period.

The display driving circuit 400 may receive digital video data RGB DATA and timing synchronization signals from the outside. The display driving circuit 400 controls the operation timing of the data driving circuit unit 200 by generating a data driving control signal DCS based on the timing synchronization signals. In addition, the display driving circuit 400 controls the operation timing of each of the first and second scan drive circuits 210 and 211 by generating the gate driving control signal GCS.

The data driving integrated circuits of the data driving circuit unit 200 output data voltages according to the digital video data RGB DATA to the pixels SP of the display unit DU based on the data driving control signal DCS. The data driving integrated circuits may supply the data voltages to the data lines DL, to which the pixels SP are connected, on a horizontal line-by-horizontal line basis every horizontal period. In addition, the data driving integrated circuits may sequentially detect pixel driving voltages received from the pixels SP for each horizontal line by switching the pixel driving voltages to the X-axis direction, which is the first horizontal direction, in response to a first direction switching signal included in the data driving control signal DCS. Conversely, the data driving integrated circuits may also sequentially detect the pixel driving voltages received from the pixels SP for each horizontal line by switching the pixel driving voltages to the −X axis direction, which is the second horizontal direction, in response to a second direction switching signal included in the data driving control signal DCS.

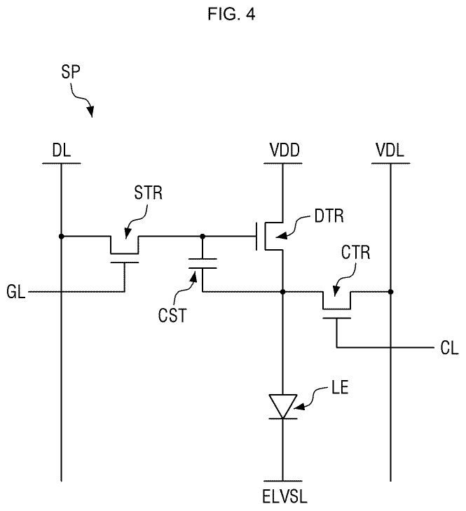

FIG. 4 is an equivalent circuit diagram of a pixel SP of the display panel 100 illustrated in FIG. 3 according to some embodiments.

Referring to FIG. 4, each pixel SP includes two transistors STR and DTR for making a light emitting element LE emit light, one storage capacitor CST, and a compensation transistor CTR transmitting a pixel driving voltage, which is supplied to the light emitting element LE, to a voltage detection line VDL.

A driving transistor DTR adjusts the amount of current flowing from a first power line VDD, to which a first power supply voltage is supplied, to the light emitting element LE according to a voltage difference between a gate electrode and a source electrode. The driving transistor DTR may have the gate electrode connected to a first electrode of a first transistor STR1, a first electrode connected to the first power line VDD to which the first power supply voltage is applied, and a second electrode connected to a first electrode of the light emitting element LE.

The first transistor STR1 is turned on by a gate scan signal of a gate line GL to connect a data voltage of a data line DL to the gate electrode of the driving transistor DTR. The first transistor STR1 may have a gate electrode connected to any one gate line GL, the first electrode connected to the data line DL, and a second electrode connected to the gate electrode of the driving transistor DTR.

The storage capacitor CST may be formed between the gate electrode and the second electrode of the driving transistor DTR. The storage capacitor CST stores a difference voltage between a gate voltage and a source voltage or drain voltage of the driving transistor DTR.

The compensation transistor CTR is turned on by a compensation gate scan signal of a compensation gate line CL to electrically connect the first electrode of the light emitting element LE and any one voltage detection line VDL. A pixel driving voltage may be supplied to the data driving circuit unit 200 through the voltage detection line VDL.

The first transistor STR1, the driving transistor DTR, and the compensation transistor CTR may be formed as thin-film transistors. In addition, although a case where the first transistor STR1, the driving transistor DTR and the compensation transistor CTR are N-type metal oxide semiconductor field effect transistors (MOSFETs) has been mainly described in FIG. 4, embodiments according to the present disclosure are not limited thereto. For example, the fist transistor STR1, the driving transistor DTR and the compensation transistor CTR may also be formed as P-type MOSFETs, or some of them may be formed as N-type MOSFETs, and the other may be formed as a P-type MOSFET.

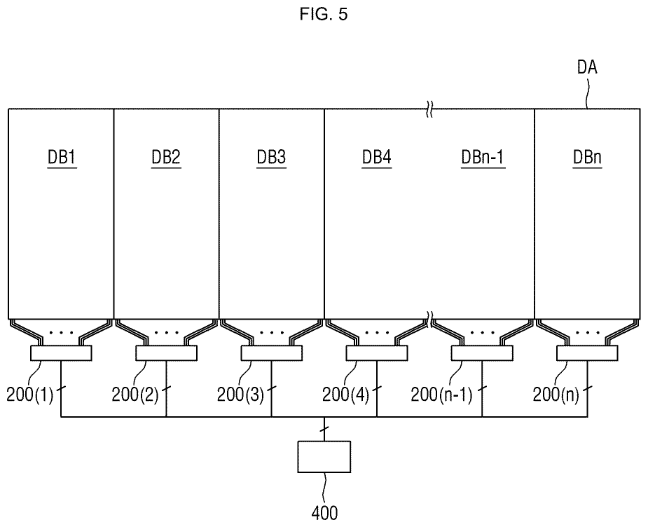

FIG. 5 is a block diagram illustrating a connection structure between a display driver, a plurality of data driving integrated circuits, and a pixel driving area for each integrated circuit according to some embodiments.

Referring to FIG. 5, the data driving circuit unit 200 may include a plurality of data driving integrated circuits 200(1) through 200(n). In addition, the display area DA where images are displayed is divided into a plurality of pixel driving areas DB1 through DBn which correspond one-to-one to the data driving integrated circuits 200(1) through 200(n) and are driven by the data driving integrated circuits 200(1) through 200(n), respectively. Here, n is a positive integer.

Each of the data driving integrated circuits 200(1) through 200(n) outputs data voltages to the data lines DL of a corresponding one of the pixel driving areas DB1 through DBn based on the data driving control signal DCS from the display driving circuit 400. Each of the data driving integrated circuits 200(1) through 200(n) divides frame image data DATA for each frame from the display driving circuit 400 into one or more horizontal lines and converts the frame image data DATA into analog data voltages for each horizontal line. Then, each of the data driving integrated circuits 200(1) through 200(n) supplies the data voltages to the data lines DL of a corresponding one of the pixel driving areas DB1 through DBn on a horizontal line-by-horizontal line basis every horizontal period based on the data driving control signal DCS.

In addition, each of the data driving integrated circuits 200(1) through 200(n) sequentially detects pixel driving voltages received from the pixels SP for each horizontal line by switching the pixel driving voltages to any one horizontal direction in response to a direction switching signal included in the data driving control signal DCS.

For example, each of the data driving integrated circuits 200(1) through 200(n) may sequentially detect the pixel driving voltages received from the pixels SP for each horizontal line by switching the pixel driving voltages to the X-axis direction, which is the first horizontal direction, in response to the first direction switching signal included in the data driving control signal DCS. In addition, each of the data driving integrated circuits 200(1) through 200(n) may sequentially detect the pixel driving voltages received from the pixels SP for each horizontal line by switching the pixel driving voltages to the −X axis direction, which is the second horizontal direction, in response to the second direction switching signal included in the data driving control signal DCS.

Each of the data driving integrated circuits 200(1) through 200(n) compares and analyzes data about the pixel driving voltages detected by sequentially switching the pixel driving voltages to any one direction with data about a preset reference voltage for each image gray level, compensates magnitudes of the data voltages with compensation data according to the analysis result, and supplies the compensated data voltages to the data lines DL of a corresponding one of the pixel driving areas DB1 through DBn.

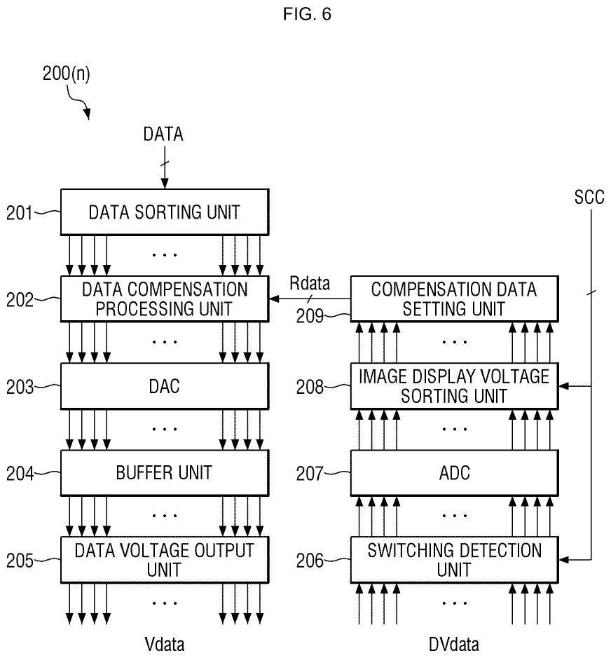

FIG. 6 is a detailed block diagram of any one data driving integrated circuit illustrated in FIG. 5.

Referring to FIG. 6, each of the data driving integrated circuits 200(1) through 200 (n) includes a data sorting unit 201, a data compensation processing unit 202, a digital-to-analog conversion unit 203, a buffer unit 204, a data voltage output unit 205, a switching detection unit 206, an analog-to-digital conversion unit 207, an image display voltage sorting unit 208, and a compensation data setting unit 209.

The data sorting unit 201 divides the frame image data DATA from the display driving circuit 400 into one or more horizontal lines to sort the frame image data DATA by horizontal line.

The data compensation processing unit 202 compensates image data of each pixel SP among the sorted image data for each horizontal line from the data sorting unit 201 with compensation data supplied from the compensation data setting unit 209. Then, the compensated image data of the pixels SP for each horizontal line are simultaneously (or concurrently) output to the digital-to-analog conversion unit 203.

The digital-to-analog conversion unit 203 converts the compensated image data of the pixels SP for each horizontal line into analog data voltages according to gray or luminance values of the data and simultaneously (or concurrently) transmits the data voltages of the pixels SP for each horizontal line to the buffer unit 204.

The buffer unit 204 charges and stores the analog data voltages of the pixels SP which are simultaneously (or concurrently) input for each horizontal line and amplifies and corrects the magnitude of the analog data voltage of each pixel SP.

The data voltage output unit 205 switches the analog data voltage of each pixel SP of the buffer unit 204 every horizontal period and supplies the analog data voltages of the pixels SP for each horizontal line to the data lines DL, respectively.

The switching detection unit 206 sequentially detects pixel driving voltages received from the pixels SP in each horizontal period by switching the pixel driving voltages to any one horizontal direction in response to any one direction switching signal SCC included in the data driving control signal DCS.

For example, the switching detection unit 206 may sequentially detect pixel driving voltages received from the pixels SP for each horizontal line by switching the pixel driving voltages to the X-axis direction, which is the first horizontal direction, in response to the first direction switching signal included in the data driving control signal DCS. Conversely, the switching detection unit 206 may also sequentially detect the pixel driving voltages received from the pixels SP for each horizontal line by switching the pixel driving voltages to the −X axis direction, which is the second horizontal direction, in response to the second direction switching signal included in the data driving control signal DCS.

The analog-to-digital conversion unit 207 converts the pixel driving voltages of the pixels SP for each horizontal line, which are sequentially detected through the switching detection unit 206 in each horizontal period, into digital data signals. Then, pixel driving voltage data of the pixels SP for each horizontal line are transmitted to the image display voltage sorting unit 208.

The image display voltage sorting unit 208 sequentially sorts the pixel driving

voltage data of the pixels SP from the analog-to-digital conversion unit 207 by horizontal line and simultaneously (or concurrently) transmits the pixel driving voltage data of the pixels SP for each horizontal line to the compensation data setting unit 209.

The compensation data setting unit 209 compares and analyzes a voltage magnitude according to the pixel driving voltage data of each pixel SP with a preset reference voltage magnitude for each image gray level. Then, the compensation data setting unit 209 extracts and sets compensation data corresponding to differences between the compared voltage magnitudes and sorts the compensation data by horizontal line. The compensation data setting unit 209 simultaneously (or concurrently) supplies the sorted compensation data Rdata for each horizontal line to the data compensation processing unit 202.

The data compensation processing unit 202 performs a compensation operation such as adding or subtracting the compensation data supplied from the compensation data setting unit 209 to or from a gray value or a luminance value included in the image data of each pixel SP. In addition, the data compensation processing unit 202 may simultaneously (or concurrently) output the compensated image data of the pixels SP for each horizontal line to the digital-to-analog conversion unit 203.

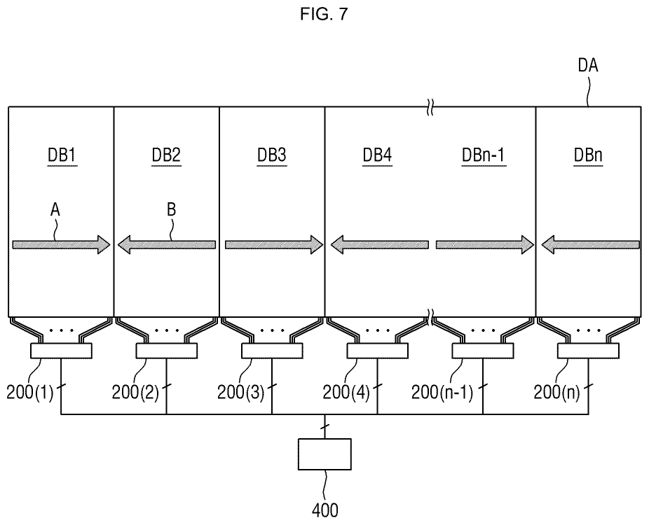

FIG. 7 is a block diagram illustrating pixel driving voltage detection directions of data driving integrated circuits according to some embodiments of the present disclosure.

Referring to FIG. 7, the display driving circuit 400 may generate first and

second direction switching signals so that data driving integrated circuits located adjacent to each other (e.g., 200(1) and 200(2), 200(3) and 200 4), . . . 200(n-1) and 200(n)) among a plurality of data driving integrated circuits 200(1) through 200(n) can sequentially switch pixel driving voltages received from pixels SP during each horizontal period to a first horizontal direction (e.g., an X-axis direction indicated by arrow A) and a second horizontal direction (e.g., a −X-axis direction indicated by arrow B) opposite to the first horizontal direction and detect the pixel driving voltages in orders of the different directions. Then, the display driving circuit 400 may supply the first and second direction switching signals respectively to the data driving integrated circuits located adjacent to each other.

For example, in at least one first frame period, the display driving circuit 400 may supply the first direction switching signal to odd-numbered data driving integrated circuits 200(1), 200(3), 200(5), . . . 200(n-1) among the data driving integrated circuits 200(1) through 200(n) to control the odd-numbered data driving integrated circuits 200(1), 200(3), 200(5), . . . 200(n-1) to detect pixel driving voltages, which are received from the pixels SP during each horizontal period, in the order of the first horizontal direction (e.g., the X-axis direction indicated by arrow A) by switching the pixel driving voltages to the first horizontal direction.

In addition, in at least one first frame period, the display driving circuit 400 may supply the second direction switching signal to even-numbered data driving integrated circuits 200(2), 200(4), 200(6), . . . 200(n) among the data driving integrated circuits 200(1) through 200(n) to control the even-numbered data driving integrated circuits 200(2), 200(4), 200(6), . . . 200(n) to detect the pixel driving voltages, which are received from the pixels SP during each horizontal period, in the order of the second horizontal direction (e.g., the −X-axis direction indicated by arrow B) opposite to the first horizontal direction by switching the pixel driving voltages to the second horizontal direction.

In at least one first frame period, the odd-numbered data driving integrated circuits 200(1), 200(3), 200(5), . . . 200(n-1) may detect the pixel driving voltages, which are received from the pixels SP in each horizontal period, in the order of the first horizontal direction by switching the pixel driving voltages to the first horizontal direction in response to the first direction switching signal. At this time, the even-numbered data driving integrated circuits 200(2), 200(4), 2006), . . . 200(n) may detect the pixel driving voltages, which are received from the pixels SP in each horizontal period, in the order of the second horizontal direction by sequentially switching the pixel driving voltages to the second horizontal direction in response to the second direction switching signal.

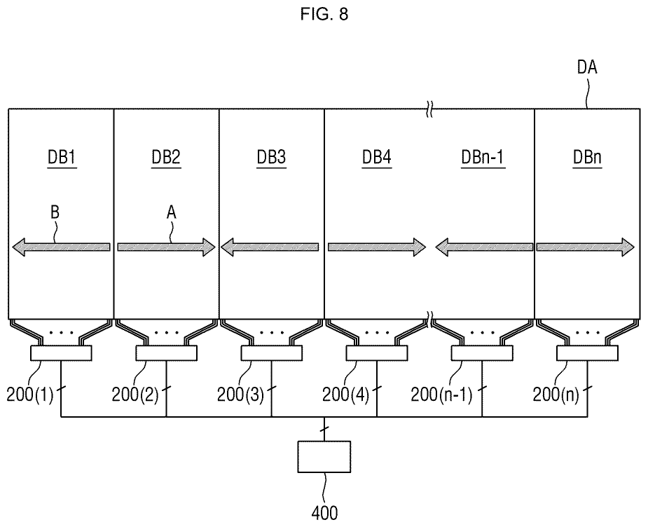

FIG. 8 is a block diagram illustrating pixel driving voltage detection directions of data driving integrated circuits according to some embodiments of the present disclosure.

Referring to FIG. 8, in at least one second frame period, the display driving circuit 400 may supply a second direction switching signal to odd-numbered data driving integrated circuits 200(1), 200(3), 200(5), . . . 200(n-1) among a plurality of data driving integrated circuits 200(1) through 200(n) to control the odd-numbered data driving integrated circuits 200(1), 200(3), 200(5), . . . 200(n-1) to detect pixel driving voltages, which are received from pixels SP during each horizontal period, in an order of a second horizontal direction (e.g., a direction indicated by arrow B) by switching the pixel driving voltages to the second horizontal direction.

In addition, in at least one second frame period, the display driving circuit 400 may supply a first direction switching signal to even-numbered data driving integrated circuits 200(2), 200(4), 200(6), . . . 200 (n) among the data driving integrated circuits 200(1) through 200() to control the even-numbered data driving integrated circuits 200(2), 200(4), 200(6), . . . 200(n) to detect the pixel driving voltages, which are received from the pixels SP during each horizontal period, in an order of a first horizontal direction (e.g., a direction indicated by arrow A) opposite to the second horizontal direction by switching the pixel driving voltages to the first horizontal direction.

In at least one second frame period, the odd-numbered data driving integrated circuits 200(1), 200(3), 200(5), . . . 200(n-1) may detect the pixel driving voltages, which are received from the pixels SP in each horizontal period, in the order of the second horizontal direction by switching the pixel driving voltages to the second horizontal direction in response to the second direction switching signal. At this time, the even-numbered data driving integrated circuits 200(2), 200(4), 200(6), . . . 200(n) may detect the pixel driving voltages, which are received from the pixels SP in each horizontal period, in the order of the first horizontal direction by sequentially switching the pixel driving voltages to the first horizontal direction in response to the first direction switching signal.

In an odd-numbered frame period among a plurality of frame periods, the display driving circuit 400 may supply the first direction switching signal to the odd-numbered data driving integrated circuits 200(1), 200(3), 200(5), . . . 200(n-1) among the data driving integrated circuits 200(1) through 200(n) to control the odd-numbered data driving integrated circuits 200(1), 200(3), 200(5), . . . 200(n-1) to detect the pixel driving voltages, which are received from the pixels SP during each horizontal period, in the order of the first horizontal direction (e.g., an X-axis direction indicated by arrow A) by switching the pixel driving voltages to the first horizontal direction.

In addition, in the odd-numbered frame period, the display driving circuit 400 may supply the second direction switching signal to the even-numbered data driving integrated circuits 200(2), 200(4), 200(6), . . . 200(n) among the data driving integrated circuits 200(1) through 200(n) to control the even-numbered data driving integrated circuits 200(2), 200(4), 200(6), . . . 200(n) to detect the pixel driving voltages, which are received from the pixels SP during each horizontal period, in the order of the second horizontal direction (e.g., a −X-axis direction indicated by arrow B) opposite to the first horizontal direction by switching the pixel driving voltages to the second horizontal direction.

In the odd-numbered frame period, the odd-numbered data driving integrated circuits 200(1), 200(3), 200(5), . . . 200n-1) may detect the pixel driving voltages, which are received from the pixels SP in each horizontal period, in the order of the first horizontal direction by switching the pixel driving voltages to the first horizontal direction in response to the first direction switching signal. At this time, the even-numbered data driving integrated circuits 200(2), 200(4), 200(6), . . . 200(n) may detect the pixel driving voltages, which are received from the pixels SP in each horizontal period, in the order of the second horizontal direction by sequentially switching the pixel driving voltages to the second horizontal direction in response to the second direction switching signal.

Conversely, in an even-numbered frame period among the frame periods, the display driving circuit 400 may supply the second direction switching signal to the odd-numbered data driving integrated circuits 200(1), 200(3), 200(5), . . . 200n-1) among the data driving integrated circuits 200(1) through 200(n) to control the odd-numbered data driving integrated circuits 200(1), 200(3), 200(5), . . . 200(n-1) to detect the pixel driving voltages, which are received from the pixels SP during each horizontal period, in the order of the second horizontal direction (e.g., the direction indicated by arrow B) by switching the pixel driving voltages to the second horizontal direction.

In addition, in the even-numbered frame period, the display driving circuit 400 may supply the first direction switching signal to the even-numbered data driving integrated circuits 200(2), 200(4), 200(6), . . . 200(n) among the data driving integrated circuits 200(1) through 200(n) to control the even-numbered data driving integrated circuits 200(2), 200(4), 200(6), . . . 200(n) to detect the pixel driving voltages, which are received from the pixels SP during each horizontal period, in the order of the first horizontal direction (e.g., the direction indicated by arrow A) opposite to the second horizontal direction by switching the pixel driving voltages to the first horizontal direction.

In the even-numbered frame period, the odd-numbered data driving

integrated circuits 200(1), 200(3), 200(5), . . . 200(n-1) may detect the pixel driving voltages, which are received from the pixels SP in each horizontal period, in the order of the second horizontal direction by switching the pixel driving voltages to the second horizontal direction in response to the second direction switching signal. At this time, the even-numbered data driving integrated circuits 200(2), 200(4), 200(6), . . . 200(n) may detect the pixel driving voltages, which are received from the pixels SP in each horizontal period, in the order of the first horizontal direction by sequentially switching the pixel driving voltages to the first horizontal direction in response to the first direction switching signal.

According to embodiments of the present disclosure, data driving integrated

circuits located adjacent to each other (e.g., 200(1) and 200(2), 200(3) and 200(4), . . . 200(n-1) and 200(n)) are driven by changing their pixel driving voltage detection directions and orders to different directions and orders. Therefore, it may be possible to reduce a difference between the amounts of distortion of pixel driving voltages, for example, a difference between the amounts of drop of pixel driving voltages detected by each of the data driving integrated circuits located adjacent to each other (e.g., 200(1) and 200(2), 200(3) and 200(4), . . . 200(n-1) and 200(n)).

In addition, in a display device according to embodiments, pixel driving voltages are detected by minimizing a difference between the amounts of distortion of pixel driving voltages of pixels located at a boundary between pixel driving areas respectively corresponding to data driving integrated circuits located adjacent to each other (e.g., 200(1) and 200(2), 200(3) and 200(4), . . . 200(n-1) and 200(n)), and data voltages are compensated according to the result of pixel driving voltage detection. Therefore, image display defects can be prevented or reduced.

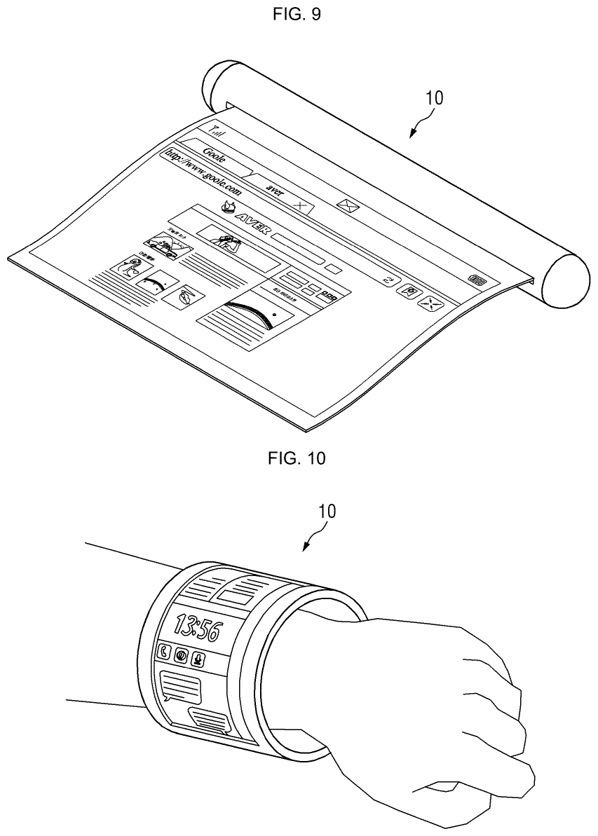

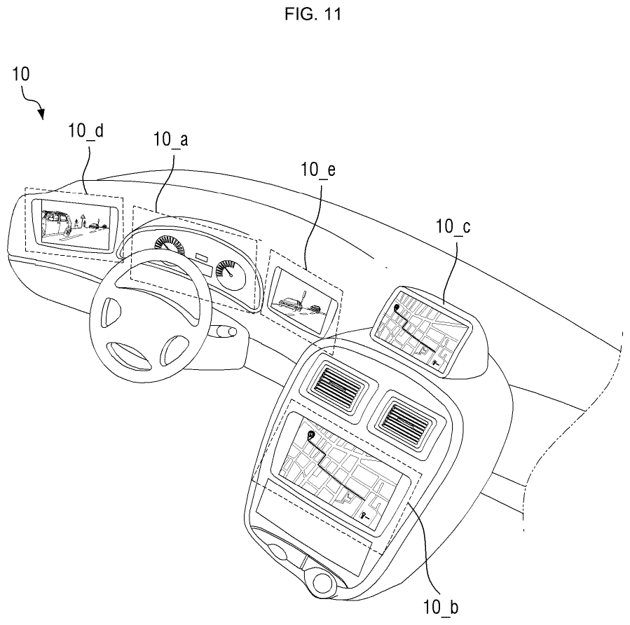

FIG. 9 is a perspective view illustrating an application example of a display device according to some embodiments of the present disclosure. FIG. 10 is a perspective view illustrating an application example of a display device according to some embodiments of the present disclosure.

Referring to FIGS. 9 and 10, a display device 10 according to some embodiments of the present disclosure may be applied to portable electronic devices such as tablet PCs, mobile communication terminals, electronic notebooks, electronic books, and UMPCs. For example, a display panel 100 of the display device 10 according to some embodiments may be bent and rolled in the X-axis direction or the Y-axis direction.

FIG. 11 is a perspective view illustrating an application example of a display device according to some embodiments of the present disclosure.

For example, FIG. 11 is an example view illustrating a vehicle instrument cluster and center fascia including a display device 10 according to some embodiments of the present disclosure. As illustrated, the display device 10 including a display panel 100 of the present disclosure may be applied to an instrument cluster 10_a of a vehicle, a center fascia 10_b of the vehicle, or a center information display (CID) 10_c located on a dashboard of the vehicle. In addition, the display device 10 according to some embodiments may be applied to room mirror displays 10_d and 10_e that replace side mirrors of the vehicle, a navigation device, etc.

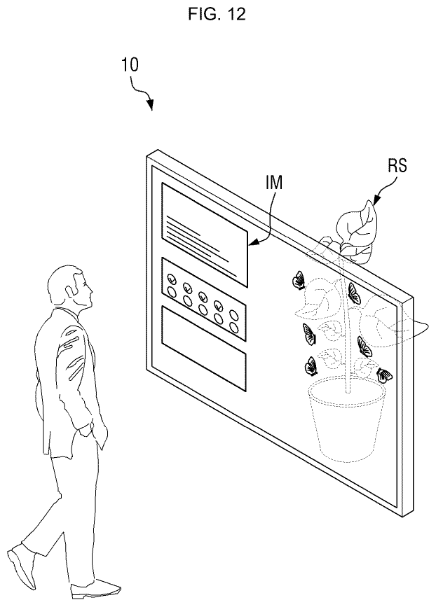

FIG. 12 is a perspective view illustrating an application example of a display device according to some embodiments of the present disclosure.

For example, FIG. 12 is an example view of a transparent display device including a display device 10 according to some embodiments of the present disclosure. As illustrated, the display device 10 including a display panel 100 of the present disclosure may be applied to a transparent display device. The transparent display device may transmit light while displaying an image IM. Therefore, a user located in front of the transparent display device cannot only view the image IM displayed on the display panel 100 but also view an object RS or the background located behind the transparent display device. When the display device 10 including the display panel 100 is applied to the transparent display device, the display panel 100 of the display device 10 may include a light transmitting portion that can transmit light or may be made of a material that can transmit light.

In concluding the detailed description, those skilled in the art will appreciate that many variations and modifications can be made to the disclosed embodiments without departing from the spirit and scope of embodiments according to the present disclosure. Therefore, the disclosed embodiments of the present disclosure are used in a generic and descriptive sense only and not for purposes of limitation.

What is claimed is:

1. A display device comprising:
a display panel in which a plurality of pixels are arranged in a display area to display an image;
a scan driving circuit configured to supply compensation gate scan signals to the pixels on a horizontal line-by-horizontal line basis through compensation gate lines of the display area;
a data driving circuit unit configured to:
detect pixel driving voltages output from the pixels by the compensation gate scan signals;
compensate and modulate data voltages using compensation data set by the pixel driving voltages; and
supply the data voltages to data lines of the display area; and
a display driving circuit configured to control a pixel driving voltage detection direction and order of the data driving circuit unit by supplying a direction switching signal to the data driving circuit unit.

2. The display device of claim 1, wherein the data driving circuit unit comprises a plurality of data driving integrated circuits, and the display driving circuit is configured to generate first and second direction switching signals so that the data driving integrated circuits adjacent to each other sequentially switch the pixel driving voltages, which are received from the pixels on a horizontal line-by-horizontal line basis during each horizontal period, to a first horizontal direction and a second horizontal direction opposite to the first horizontal direction and detect the pixel driving voltages in orders of the different directions and to supply the first and second direction switching signals different from each other respectively to the data driving integrated circuits adjacent to each other.

3. The display device of claim 2, wherein the data driving integrated circuits adjacent to each other are configured to sequentially switch the pixel driving voltages, which are output from the pixels on a horizontal line-by-horizontal line basis, to the first horizontal direction and the second horizontal direction opposite to the first horizontal direction in response to the first and second direction switching signals different from each other and to detect the pixel driving voltages in the orders of the different directions.

4. The display device of claim 2, wherein the data driving integrated circuits adjacent to each other are configured to detect the pixel driving voltages, which are output on a horizontal line-by-horizontal line basis by the compensation gate scan signals, in the orders of the first and second horizontal directions different from each other in response to the first and second direction switching signals, respectively, to compare and analyze the pixel driving voltages detected in the orders of the different directions with a reference voltage for each image gray level, and to generate the compensation data according to the analysis result.

5. The display device of claim 4, wherein the data driving integrated circuits are configured to compare and analyze data about the pixel driving voltages detected by sequentially switching the pixel driving voltages to the first or second horizontal direction with data about a preset reference voltage for each image gray level, to compensate voltage magnitudes of the data voltages with the compensation data according to the analysis result, and to supply the data voltages to the data lines of each pixel driving area.

6. The display device of claim 2, wherein in at least one first frame period, the display driving circuit is configured to supply the first direction switching signal to odd-numbered data driving integrated circuits among the data driving integrated circuits to control the odd-numbered data driving integrated circuits to detect the pixel driving voltages, which are received from the pixels during each horizontal period, in an order of the first horizontal direction by sequentially switching the pixel driving voltages to the first horizontal direction and to supply the second direction switching signal to even-numbered data driving integrated circuits among the data driving integrated circuits to control the even-numbered data driving integrated circuits to detect the pixel driving voltages, which are received from the pixels during each horizontal period, in an order of the second horizontal direction opposite to the first horizontal direction by switching the pixel driving voltages to the second horizontal direction.

7. The display device of claim 6, wherein in the at least one first frame period, the odd-numbered data driving integrated circuits are configured to detect the pixel driving voltages, which are received from the pixels in each horizontal period, in the order of the first horizontal direction by switching the pixel driving voltages to the first horizontal direction, and the even-numbered data driving integrated circuits detect the pixel driving voltages, which are received from the pixels in each horizontal period, in the order of the second horizontal direction by sequentially switching the pixel driving voltages to the second horizontal direction.

8. The display device of claim 6, wherein in at least one second frame period, the display driving circuit is configured to supply the second direction switching signal to the odd-numbered data driving integrated circuits to control the odd-numbered data driving integrated circuits to detect the pixel driving voltages, which are received from the pixels, in the order of the second horizontal direction and supplies the first direction switching signal to the even-numbered data driving integrated circuits to control the even-numbered data driving integrated circuits to detect the pixel driving voltages, which are received from the pixels, in the order of the first horizontal direction by switching the pixel driving voltages to the first horizontal direction.

9. The display device of claim 2, wherein in an odd-numbered frame period among a plurality of frame periods, the display driving circuit is configured to supply the first direction switching signal to the odd-numbered data driving integrated circuits among the data driving integrated circuits to control odd-numbered data driving integrated circuits to detect the pixel driving voltages, which are received from the pixels during each horizontal period, in an order of the first horizontal direction by sequentially switching the pixel driving voltages to the first horizontal direction and supplies the second direction switching signal to even-numbered data driving integrated circuits among the data driving integrated circuits to control the even-numbered data driving integrated circuits to detect the pixel driving voltages, which are received from the pixels during each horizontal period, in an order of the second horizontal direction opposite to the first horizontal direction by switching the pixel driving voltages to the second horizontal direction.

10. The display device of claim 9, wherein in an even-numbered frame period among the frame periods, the display driving circuit is configured to supply the second direction switching signal to the odd-numbered data driving integrated circuits to control the odd-numbered data driving integrated circuits to detect the pixel driving voltages, which are received from the pixels, in the order of the second horizontal direction and supplies the first direction switching signal to the even-numbered data driving integrated circuits to control the even-numbered data driving integrated circuits to detect the pixel driving voltages, which are received from the pixels, in the order of the first horizontal direction by switching the pixel driving voltages to the first horizontal direction.

11. A display device comprising:
a display panel in which a plurality of pixels are arranged in a display area to display an image;
a scan driving circuit configured to supply compensation gate scan signals to the pixels on a horizontal line-by-horizontal line basis through compensation gate lines of the display area;
a plurality of data driving integrated circuits configured to detect pixel driving voltages output from the pixels by the compensation gate scan signals, to compensate and modulate data voltages using compensation data set by the pixel driving voltages, and to supply the data voltages to data lines of the display area; and
a display driving circuit configured to supply first and second direction switching signals different from each other to data driving integrated circuits adjacent to each other among the data driving integrated circuits so that the data driving integrated circuits adjacent to each other can detect the pixel driving voltages, which are received from the pixels, in orders of first and second horizontal directions different from each other.

12. The display device of claim 11, wherein the data driving integrated circuits adjacent to each other are configured to sequentially switch the pixel driving voltages, which are output from the pixels on a horizontal line-by-horizontal line basis, to the first horizontal direction and the second horizontal direction opposite to the first horizontal direction in response to the first and second direction switching signals different from each other and to detect the pixel driving voltages in the orders of the different directions.

13. The display device of claim 11, wherein the data driving integrated circuits adjacent to each other are configured to detect the pixel driving voltages, which are output on a horizontal line-by-horizontal line basis by the compensation gate scan signals, in the orders of the first and second horizontal directions different from each other in response to the first and second direction switching signals, respectively, to compare and analyze the pixel driving voltages detected in the orders of the different directions with a reference voltage for each image gray level, and to generate the compensation data according to the analysis result.

14. The display device of claim 13, wherein in at least one first frame period, the display driving circuit is configured to supply the first direction switching signal to odd-numbered data driving integrated circuits among the data driving integrated circuits to control the odd-numbered data driving integrated circuits to detect the pixel driving voltages, which are received from the pixels during each horizontal period, in the order of the first horizontal direction by sequentially switching the pixel driving voltages to the first horizontal direction and to supply the second direction switching signal to even-numbered data driving integrated circuits among the data driving integrated circuits to control the even-numbered data driving integrated circuits to detect the pixel driving voltages, which are received from the pixels during each horizontal period, in the order of the second horizontal direction opposite to the first horizontal direction by switching the pixel driving voltages to the second horizontal direction.

15. The display device of claim 14, wherein in the at least one first frame period, the odd-numbered data driving integrated circuits are configured to detect the pixel driving voltages, which are received from the pixels in each horizontal period, in the order of the first horizontal direction by switching the pixel driving voltages to the first horizontal direction, and the even-numbered data driving integrated circuits detect the pixel driving voltages, which are received from the pixels in each horizontal period, in the order of the second horizontal direction by sequentially switching the pixel driving voltages to the second horizontal direction.

16. The display device of claim 14, wherein in at least one second frame period, the display driving circuit is configured to supply the second direction switching signal to the odd-numbered data driving integrated circuits to control the odd-numbered data driving integrated circuits to detect the pixel driving voltages, which are received from the pixels, in the order of the second horizontal direction and supplies the first direction switching signal to the even-numbered data driving integrated circuits to control the even-numbered data driving integrated circuits to detect the pixel driving voltages, which are received from the pixels, in the order of the first horizontal direction by switching the pixel driving voltages to the first horizontal direction.

17. The display device of claim 13, wherein in an odd-numbered frame period among a plurality of frame periods, the display driving circuit is configured to supply the first direction switching signal to odd-numbered data driving integrated circuits among the data driving integrated circuits to control the odd-numbered data driving integrated circuits to detect the pixel driving voltages, which are received from the pixels during each horizontal period, in the order of the first horizontal direction by sequentially switching the pixel driving voltages to the first horizontal direction and to supply the second direction switching signal to even-numbered data driving integrated circuits among the data driving integrated circuits to control the even-numbered data driving integrated circuits to detect the pixel driving voltages, which are received from the pixels during each horizontal period, in the order of the second horizontal direction opposite to the first horizontal direction by switching the pixel driving voltages to the second horizontal direction.

18. The display device of claim 17, wherein in an even-numbered frame period among the frame periods, the display driving circuit is configured to supply the second direction switching signal to the odd-numbered data driving integrated circuits to control the odd-numbered data driving integrated circuits to detect the pixel driving voltages, which are received from the pixels, in the order of the second horizontal direction and to supply the first direction switching signal to the even-numbered data driving integrated circuits to control the even-numbered data driving integrated circuits to detect the pixel driving voltages, which are received from the pixels, in the order of the first horizontal direction by switching the pixel driving voltages to the first horizontal direction.

19. The display device of claim 11, wherein each of the data driving integrated circuits comprises:
a switching detection unit configured to sequentially detect the pixel driving voltages received from the pixels in each horizontal period by switching the pixel driving voltages to the first or second horizontal direction in response to the first or second direction switching signal;
an analog-to-digital conversion unit configured to convert the pixel driving voltages of the pixels for each horizontal line, which are sequentially detected through the switching detection unit, into digital data signals;
an image display voltage sorting unit configured to sequentially sort pixel driving voltage data of the pixels by horizontal line; and
a compensation data setting unit configured to compare voltage magnitudes according to the pixel driving voltage data of the pixels with a preset reference voltage magnitude for each image gray level, to set the compensation data corresponding to differences between the compared voltage magnitudes and sorting the compensation data by horizontal line, and to supply the compensation data for each horizontal line to a data compensation processing unit.

20. An electronic device including a display device, the display device comprising:
a display panel in which a plurality of pixels are arranged in a display area to display an image;
a scan driving circuit configured to supply compensation gate scan signals to the pixels on a horizontal line-by-horizontal line basis through compensation gate lines of the display area;
a data driving circuit unit configured to:
detect pixel driving voltages output from the pixels by the compensation gate scan signals;
compensate and modulate data voltages using compensation data set by the pixel driving voltages; and
supply the data voltages to data lines of the display area; and
a display driving circuit configured to control a pixel driving voltage detection direction and order of the data driving circuit unit by supplying a direction switching signal to the data driving circuit unit.
